(19) United States
(12) Patent Application Publication
(10) Pub. No.: US 2015/0377357 A1
(43) Pub. Date: Dec. 31, 2015

(54) V-RING SEAL WITH WIPERS

(71) Applicants: Yefim Epshetsky, Schaumburg, IL (US); Gregory G. Gildea, Village of Lakewood, IL (US); Maria Concepcion Martin, Madrid (ES)

(72) Inventors: Yefim Epshetsky, Schaumburg, IL (US); Gregory G. Gildea, Village of Lakewood, IL (US); Maria Concepcion Martin, Madrid (ES)

(73) Assignee: AKTIEBOLAGET SKF, Goteborg (SE)

(21) Appl. No.: 14/319,650

(22) Filed: Jun. 30, 2014

(51) Int. Cl. F16J 15/32

(52) U.S. Cl. CPC F16J 15/3232; F16J 15/3268

(57) ABSTRACT

A seal assembly is for sealing a space between first and second members and includes a generally annular elastomeric seal body disposed about an outer surface of the first member and extending circumferentially about a central axis. The body includes a base portion and a sealing portion, the sealing portion having an inner end integrally formed with the base portion and an outer, free end sealingly engageable with an axial surface of the second member so as to define a generally annular seal interface. A wiper is coupled with the seal body and has an engagement portion contactable with an axial surface of the second member at a position spaced radially outwardly from the sealing portion outer end. As such, the wiper engagement portion directs substances on the second member axial surface generally away from the sealing interface when the wiper contacts the substances during rotation of the rotatable member.

### BACKGROUND OF THE INVENTION

The present invention relates to seals, and more particularly to V-ring seals for sealing against axial surfaces.

V-ring axial seals are known and typically include an annular elastomeric body having a main body portion and a cantilever-like sealing portion extending from the main body portion. The seal body is disposed on a shaft or other mechanical member and the sealing portion engages with an axial surface of another, adjacent mechanical member so as to seal an axial space between the shaft/member and the other member.

Although such seals are generally effective, the integrity of the seal between the sealing portion and the axial surface can be affected when dust or other debris enters the interface between the sealing portion and surface. That is, dust or debris may become disposed between the seal body sealing portion and the axial surface, which if accumulating in sufficient quantity, can create an opening for liquids or other substances to pass therethrough.

### SUMMARY OF THE INVENTION

In one aspect, the present invention is a seal assembly for sealing a space between first and second members, the first member having a central axis and an outer circumferential surface extending about the axis, the second member having a radially-extending axial surface, at least one of the first and second members being a rotatable member. The seal assembly comprises a generally annular elastomeric seal body disposed about the first member outer surface and extending circumferentially about the central axis. The body includes a base portion and a sealing portion, the sealing portion having an inner end integrally formed with the base portion and an outer, free end sealingly engageable with the second member axial surface so as to define a generally annular seal interface. A wiper is coupled with the seal body and has an engagement portion contactable with the second member axial surface at a position spaced radially outwardly from the sealing portion outer end. The wiper engagement portion is configured to direct substances disposed on the second member axial surface generally away from the sealing interface when the wiper contacts the substances during rotation of the rotatable member.

In another aspect, the present invention is again a seal assembly for sealing a space between first and second members, the first member having a central axis and an outer circumferential surface extending about the axis, the second member having a radially-extending axial surface, at least one of the first and second members being a rotatable member. The seal assembly comprises a generally annular elastomeric seal body disposed about the first member outer surface and extending circumferentially about the central axis. The body includes a base portion and a sealing portion having an inner end integrally formed with the base portion and an outer, free end sealingly engageable with the second member axial surface, a generally annular cavity being defined between the base portion and the sealing portion. A biasing member is disposed within the annular cavity and is configured to exert a generally radially-inwardly directed force on the seal body so as to substantially prevent relative angular displacement between the seal body and the first member. A wiper has a retention portion disposed between the biasing member and the seal body, so as to couple the wiper with the seal body, and an engagement portion contactable with the second member axial surface at a position spaced radially outwardly from the sealing portion outer end.

In a further aspect, the present invention is once again a seal assembly for sealing a space between first and second members, the first member having a central axis and an outer circumferential surface extending about the axis, the second member having a radially-extending axial surface, at least one of the first and second members being a rotatable member. The seal assembly comprises a generally annular elastomeric seal body disposed about the first member outer surface and extending circumferentially about the central axis. The body includes a base portion and a sealing portion having an inner end integrally formed with the base portion and an outer, free end sealingly engageable with the second member axial surface so as to define a generally annular seal interface. A first wiper is coupled with the seal body and has an engagement portion contactable with the second member axial surface at a position spaced radially outwardly from the sealing portion outer end. Further, a second wiper is spaced circumferentially from the first wiper, is coupled with the seal body and has an engagement portion contactable with the second member axial surface at a position spaced radially outwardly from the sealing portion outer end.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of a machine assembly having a seal assembly with wipers in accordance with the present invention;

FIG. 2 is a broken-away, enlarged view of an upper portion of FIG. 1;

FIG. 3 is a view through line 3-3 of FIG. 2;

FIG. 4 is an enlarged view of a portion of FIG. 3;

FIG. 5 is an axial cross-sectional view of the seal assembly, shown separate from the machine assembly;

FIG. 6 is a top plan view of an exemplary construction of a wiper; and

FIG. 7 is a side plan view of the wiper of FIG. 6.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

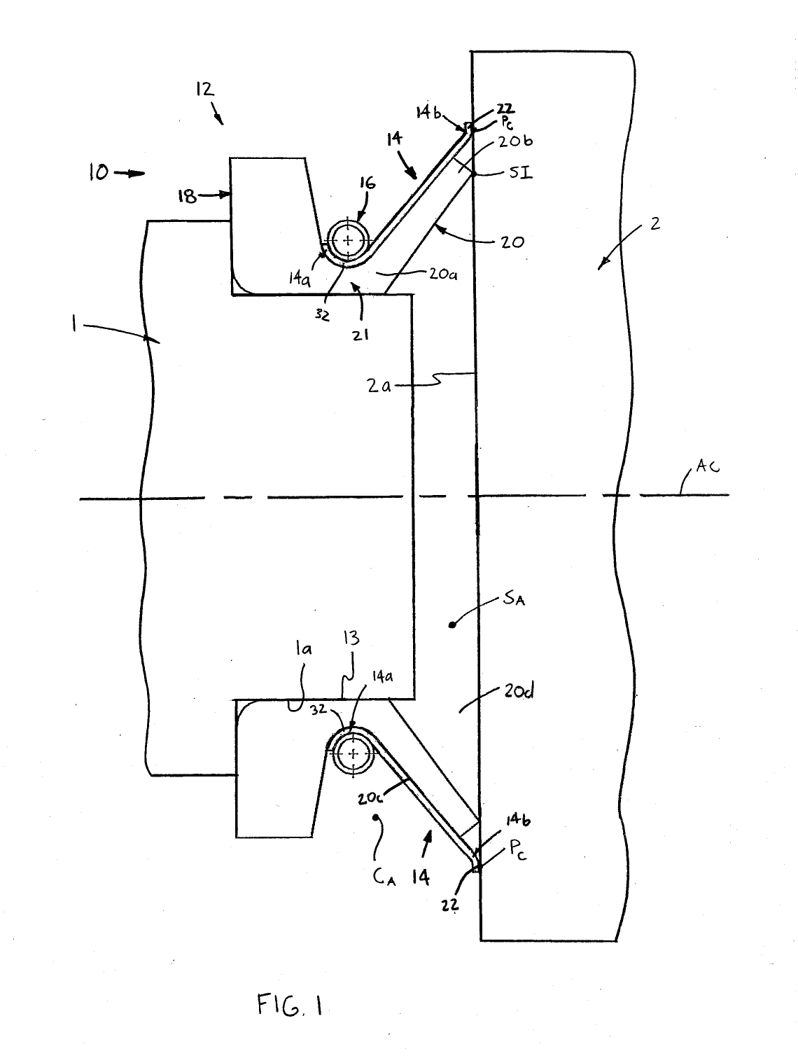

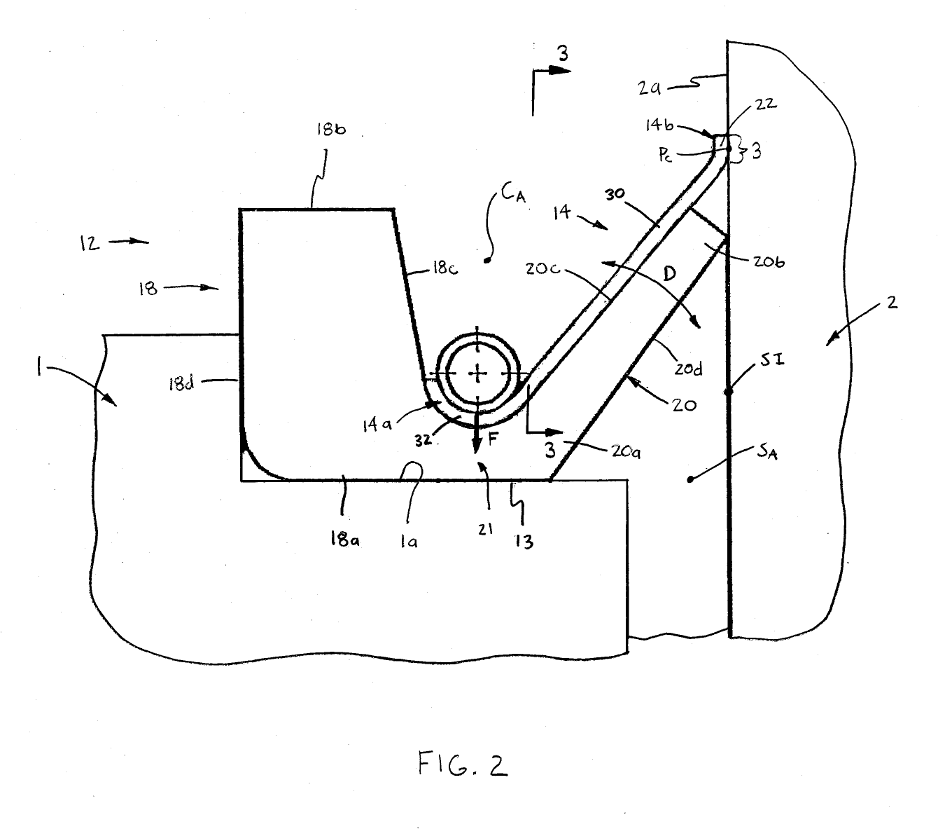

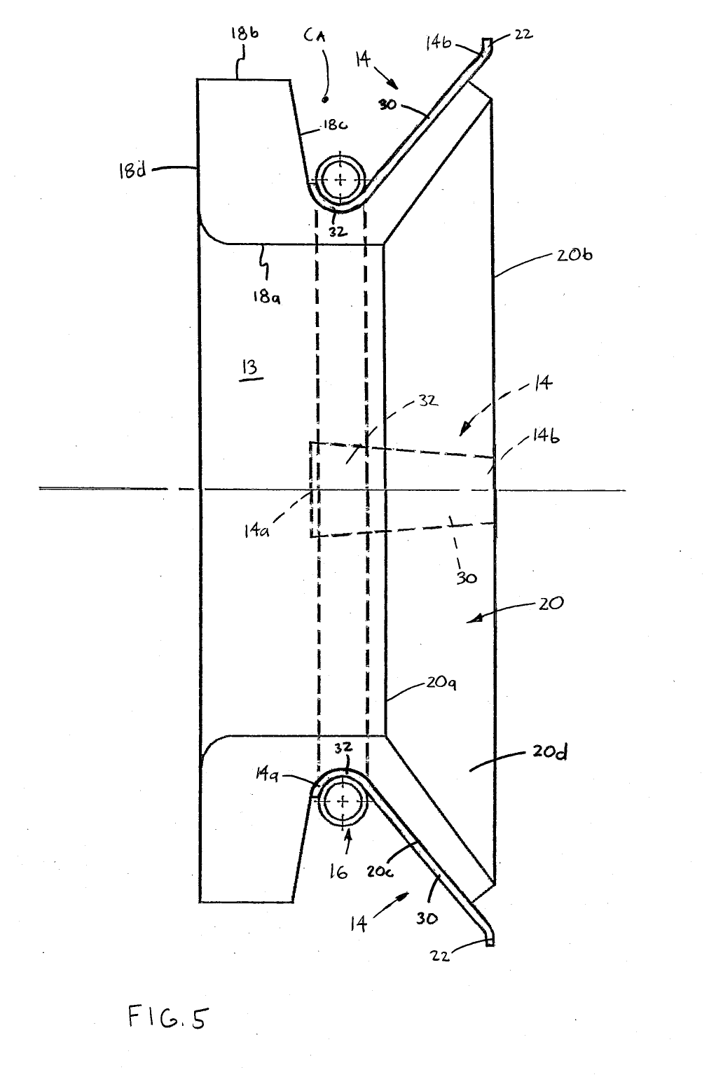

Referring now to the drawings in detail, wherein like numbers are used to indicate like elements throughout, there is shown in FIGS. 1-7 a seal assembly 10 for sealing a space S_{A} between first and second members 1, 2, respectively. The first member 1 has a central axis A_{C} and an outer circumferential surface 1a extending about the axis A_{C} and the second member 2 has a radially-extending axial surface 2a, i.e., “axial” in the sense of being located generally at a particular position on the central axis A_{C}. At least one of the first and second members 1, 2 is a rotatable member, that is, the member 1 or 2 is rotatable about the central axis A_{C}. The seal assembly 10 basically comprises a generally annular elastomeric seal body 12 and at least one and preferably a plurality of wipers 14 spaced circumferentially about the axis A_{C}, and preferably also includes a biasing member 16. The seal body 12 is disposed about the first member outer surface 1a and extends circumferentially about the central axis A_{C}, and preferably has an inner circumferential sealing surface 13 sealingly engageable with the first member outer circumferential surface 1a. The seal body 12 includes a base portion 18 and a sealing portion 20, the sealing portion 20 having an inner end 20a integrally formed with the base portion 18 and an outer, free end 20b. The sealing portion outer end 20b is sealingly engageable with the second member axial surface 2a so as to define a generally annular seal interface SI. Further, a generally annular cavity C_{A} is defined between the base portion 18 and the sealing portion 20, and the body 12 preferably further includes an integral hinge portion 21 connecting the sealing portion 20 with the base portion 18. As such, the sealing portion 20 is deflectable about the hinge portion 21 in generally axial directions with respect to the base portion 18, as indicated by arrow D in FIG. 2.

Further, each wiper 14 is coupled with the seal body 12 and has an engagement portion 22 contactable with the second member axial surface 2a at a position P_{C} spaced radially outwardly from the sealing portion outer end 20b, and thus also radially outwardly from the sealing interface SI. The wiper engagement portion 22 is configured to direct substances X (e.g., dust, metallic particles, liquids, etc.) disposed on the second member axial surface 2a generally away from the sealing interface SI when the wiper 14 contacts the substances X during rotation of the rotatable member 1 or 2, as depicted in FIG. 4. More specifically, each wiper 14 has opposing first and second ends 14a, 14b, respectively, the second end 14b providing the engagement portion 22, and at least one and preferably two side edges 24A, 24B extending generally radially between the first and second ends 14a, 14b. Each side edge 24A, 24B is slideable against the second member axial surface 2a during rotation of the rotatable member 1 or 2 so as to sweep substances X from the second member axial surface 2a, and thus engages with the surface 2a generally in the manner of a scraper or squeegee.

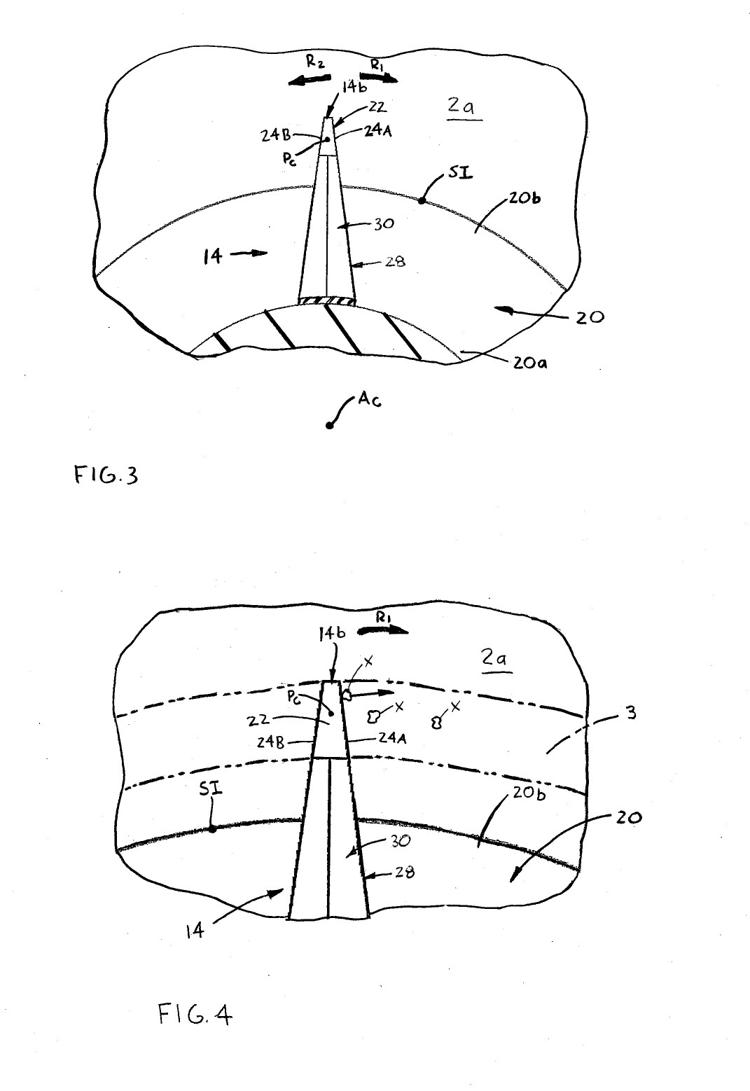

Specifically, one of the two side edges 24A slides against the second member axial surface 2a when the rotatable member 1 or 2 rotates in a first direction R₁ about the central axis A_{C} and the other one of the two edges 24B slides against the second member axial surface 2A when the rotatable member 1 or 2 rotates in a second, opposing direction R₂ about the central axis A_{C}, as indicated in FIG. 3. Further, each wiper side edge 24A, 24B is preferably angled so as to face generally away from the central axis A_{C}, to thereby better direct substances generally radially away from the sealing interface SI. With this structure, each wiper engagement portion 22 sweeps through a generally annular band 3 (FIGS. 2 and 4) on the axial surface 2a so as to direct or push substances X located within this band 3 generally away from the sealing interface SI, as best shown in FIG. 4. The wiper engagement portion 22 continues to displace or push these substances X until displaced to a location where the substances X fall or drop away from the sealing interface SI due to gravity. Thus, the one or more wipers 14 thereby prevent such substances X from reaching the sealing interface SI and potentially breaching the integrity of the seal between the sealing portion 20 and the axial surface 2a.

Referring now to FIGS. 1, 2 and 5, the annular elastomeric seal body 12 is preferably formed as a conventional “V-ring” seal. As such, the elastomeric body 12 has generally V-shaped axial cross-sections, i.e., cross-sections taken along the axis A_{C}, as best shown in FIG. 3. More specifically, the base portion 18 has a generally rectangular cross-sectional shape and the sealing portion 20 is preferably generally cantilever-like in cross-section, with the joint portion 21 extending generally axially between the two sections 18, 20. Further, the body base portion 18 has inner and outer radial ends 18a, 18b and opposing inner and outer axial ends 18c, 18d, and the body sealing portion 20 has inner and outer angled surfaces 20c, 20d, which each extend both generally radially and generally circumferentially. Thus, the annular cavity C_{A} is substantially bounded or defined by the base portion inner axial end 18c and the sealing portion outwardly-facing angled surface 20c.

Furthermore, the inner end 20a of the body sealing portion 20 is integrally formed with the base inner axial end 18c at a position proximal to the base inner radial end 18a, most preferably being coupled by the integral hinge section 21. Thus, the sealing portion 20 extends from the sealing portion inner end 20a to the sealing portion outer, free end 20b both generally radially outwardly and generally axially away from the body base portion 16. However, the seal body 12 may have any appropriate shape that includes a generally cantilever-like section for sealing axially against a radially-extending surface.

Still referring to FIGS. 1, 2 and 5, the biasing member 16 is disposed within the annular cavity C_{A} and is configured to exert a generally radially-inwardly directed force F on the seal body 12, as indicated in FIG. 2. The force F generated by the biasing member 16 substantially prevents relative angular displacement between the seal body 12 and the first member 1, provides a sealing pressure between the body inner surface 13 and the first member outer surface 1a, and releasably retains the wiper 14 coupled with the seal body 12, as described below. Preferably, the biasing member 13 is a garter spring, as depicted in FIGS. 1, 2 and 5, but may alternatively be constructed as any other type of member or assembly capable of exerting a radially-inwardly directed force on the seal body 12.

With the above-described structure of the seal body 12 and biasing member 16, each wiper 14 is preferably partially disposed within the seal body annular cavity C_{A} and extends generally radially outwardly from the cavity C_{A} and beyond the outer end 20b of the seal body sealing portion 20. Preferably, each wiper 14 is disposed generally against the sealing portion inner angled surface 20c such that the body sealing portion 20 provides support for the wiper 14, which is preferably at least generally flexible as discussed below. Further, each of the one or more wipers 14 is preferably coupled with the biasing member 16 to connect the particular wiper 14 with the seal body 12. Most preferably, each wiper 14 has a retention portion 32 disposed generally between the biasing member 16 and the seal body 12 to releasably retain the wiper 14, as discussed below. However, each wiper 14 may alternatively be attached to the biasing member 16 by clips or other fastening means or may even be directly attached to seal body 12 (e.g., by inserting the wiper inner end 14a within a slot (not shown) in the base portion 18, etc.)

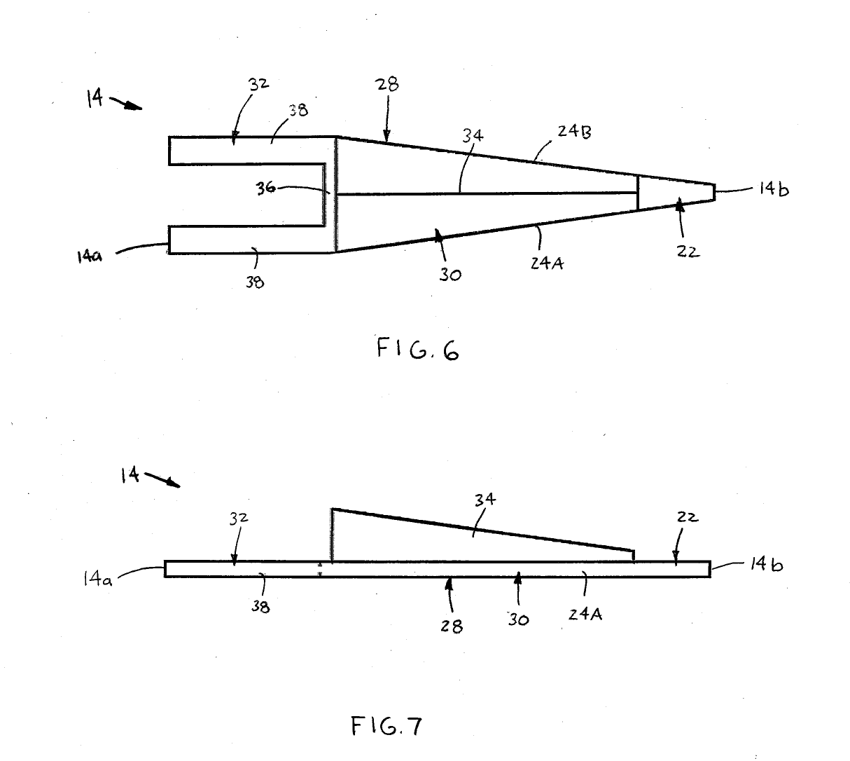

Referring to FIGS. 6 and 7, each wiper 14 preferably includes a generally plate-like body 28 having a generally triangular section 30 providing the wiper engagement portion 22 and a generally rectangular base or retention portion 32. The triangular body section 30 includes the side edges 24A, 24B, which generally converge toward the wiper second end 14b, and preferably also includes a reinforcing rib 34 extending generally radially between the first and second ends 14a, 14b. The reinforcing rib 34 provides a degree of rigidity to the central portion of the wiper 14, as both the engagement portion 22 and the base/retention portion 32 are each preferably generally flexible, as discussed below. Further, the retention portion 32 is preferably formed of a transverse bar 36 attached to the triangular section 30 and a pair of generally parallel rectangular bars 38 extending from the transverse bar 36 and providing the wiper first end 14a. Preferably, each wiper 14 is of one-piece construction, such that the two main body sections 30 and 32 are integrally formed, but may alternatively be formed as two or more separate pieces joined by any appropriate means.

Further, each wiper 14 is preferably formed of an elastomer or a flexible polymeric material with a sufficient flexibility such that the engagement and retention portions 22, 32, respectively, are bendable relative to the remainder of the wiper 14 and also have a certain degree of elasticity to maintain contact between the engagement portion 22 and the axial surface 2a. Specifically, the retention portion 32 is bendable to fit within the curved hinge area of the cavity C_{A} so as to be disposed between the biasing member 16 and the seal body 12. Also, the wiper engagement portion 22 is bendable relative to the remainder of the triangular section 30, so as to be juxtaposeable against the relatively flat axial surface 2a, while having a sufficient material elasticity to exert pressure against the axial surface 2a so as to maintain contact between the engagement portion 22 and the surface 2a.

Although preferably formed as described above, each wiper 14 may be formed or constructed in any other appropriate way that is capable of functioning as generally described herein. For example, the wiper body 28 may be formed as the generally triangular plate-like body but without the reinforcing rib or/and with a solid rectangular/square retention portion, may be formed as a generally rectangular plate, may be formed as an elongated flexible bar with circular, elliptical, or square cross-sections, etc. Also, each wiper 14 may alternatively be formed of a generally rigid polymeric or metallic material, in which case the engagement portion 22 and the retainer portion 32 are preferably formed in a bended state relative to the remainder of the wiper 14 (i.e., as shown installed in seal assembly 10 in FIGS. 1, 2 and 5).

Thus, each wiper 14 may be constructed with any appropriate structure that is coupleable with the seal body 12 and has an engagement portion 22 engageable with the second member axial surface 2a as described herein. Further, although the engagement portion 22 of each wiper 14 is depicted as a relatively small end portion of the triangular wiper body 28 that sweeps across a relatively narrow annular band 3 of the axial surface 2a, each engagement portion 22 may be formed generally larger than depicted, so as to cover a wider annular surface band 3, or generally smaller than depicted, even to the extent that the annular band 3 is essentially a circle (i.e., the band 3 has negligible radial width).

Furthermore, the seal assembly 10 may include only a single wiper 14 or any desired number of wipers 14 spaced circumferentially apart about the central axis A_{C}. Finally, although each wiper 14 is depicted as being substantially identically sized as each other wiper 14, the wipers 14 may be formed of varying lengths such that each wiper 14 contacts a different circumferential band 3 on the axial surface 2a. In such a construction, the wipers 14 would sweep across a plurality of concentric bands 3 on the second member axial surface 2a (structure not depicted).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

We claim:

1. A seal assembly for sealing a space between first and second members, the first member having a central axis and an outer circumferential surface extending about the axis, the second member having a radially-extending axial surface, at least one of the first and second members being a rotatable member, the seal assembly comprising:
a generally annular elastomeric seal body disposed about the first member outer surface and extending circumferentially about the central axis, the body including a base portion and a sealing portion, the sealing portion having an inner end integrally formed with the base portion and an outer, free end sealingly engageable with the second member axial surface so as to define a generally annular seal interface; and
a wiper coupled with the seal body and having an engagement portion contactable with the second member axial surface at a position spaced radially outwardly from the sealing portion outer end, the wiper engagement portion being configured to direct substances disposed on the second member axial surface generally away from the sealing interface when the wiper contacts the substances during rotation of the rotatable member.

2. The seal assembly as recited in claim 1 further comprising at least one other wiper coupled with the seal body and spaced circumferentially about the axis from the wiper.

3. The seal assembly as recited in claim 1 wherein the wiper has opposing first and second ends, the second end providing the engagement portion, and at least one side edge extending generally radially between the first and second ends, the side edge being slideable against the second member axial surface during rotation of the rotatable member so as to sweep substances from the second member axial surface.

4. The seal assembly as recited in claim 3 wherein the at least one wiper side edge is angled so as to face generally away from the central axis.

5. The seal assembly as recited in claim 1 wherein the wiper includes a generally plate-like body having a generally triangular section providing the wiper engagement portion, the triangular section having two opposing side edges, at least a portion of one of the two edges being slideable against the second member axial surface during rotation of rotatable member so as to sweep substances from the second member axial surface.

6. The seal assembly as recited in claim 5 wherein one of the two triangular portion edges slides against the second member axial surface when the rotatable member rotates in a first direction about the central axis and the other one of the two edges slides against the second member axial surface when the rotatable member rotates in a second, opposing direction about the central axis.

7. The seal assembly as recited in claim 1 wherein a generally annular cavity is defined between the seal body base portion and the seal body sealing portion, the annular cavity facing generally radially outwardly, the wiper being partially disposed within the cavity and extending generally radially outwardly from the cavity and beyond the outer end of the seal body sealing portion.

8. The seal assembly as recited in claim 7 further comprising a biasing member disposed within the annular cavity and configured to exert a generally radially-inwardly directed force on the seal body, the wiper being coupled with the biasing member to connect the wiper with the seal body.

9. The seal assembly as recited in claim 8 wherein the wiper has a retention portion disposed generally between the biasing member and the seal body to releasably retain the wiper.

10. The seal assembly as recited in claim 1 wherein the elastomeric seal body has generally V-shaped axial cross-sections and an inner circumferential surface sealingly engageable with the first member outer circumferential surface.

12. A seal assembly for sealing a space between first and second members, the first member having a central axis and an outer circumferential surface extending about the axis, the second member having a radially-extending axial surface, at least one of the first and second members being a rotatable member, the seal assembly comprising:
a generally annular elastomeric seal body disposed about the first member outer surface and extending circumferentially about the central axis, the body including a base portion and a sealing portion having an inner end integrally formed with the base portion and an outer, free end sealingly engageable with the second member axial surface, a generally annular cavity being defined between the base portion and the sealing portion;
a biasing member disposed within the annular cavity and configured to exert a generally radially-inwardly directed force on the seal body so as to substantially prevent relative angular displacement between the seal body and the first member; and
a wiper having a retention portion disposed between the biasing member and the seal body so as to couple the wiper with the seal body and an engagement portion contactable with the second member axial surface at a position spaced radially outwardly from the sealing portion outer end.

12. The seal assembly as recited in claim 11 wherein the wiper engagement portion is configured to direct substances disposed on the second member axial surface generally away from the sealing interface when the wiper contacts the substances during rotation of the rotatable member.

13. The seal assembly as recited in claim 11 further comprising at least one other wiper spaced circumferentially from the wiper and having a retention portion, the retention portion being disposed between the biasing member and the seal body so as to couple the other wiper with the seal body, and an engagement portion contactable with the second member axial surface at a position spaced radially outwardly from the sealing portion outer end

14. The seal assembly as recited in claim 11 wherein the wiper has opposing first and second ends, the second end providing the engagement portion, and at least one side edge extending generally radially between the first and second ends, the side edge being slideable against the second member axial surface during rotation of the rotatable member so as to sweep substances from the second member axial surface.

15. The seal assembly as recited in claim 14 wherein the at least one wiper side edge is angled so as to face generally away from the central axis.

16. The seal assembly as recited in claim 11 wherein the wiper includes a generally plate-like body having a generally triangular section providing the wiper engagement portion, the triangular section having two opposing side edges, at least a portion of one of the two edges being slideable against the second member axial surface during rotation of rotatable member so as to sweep substances from the second member axial surface.

17. The seal assembly as recited in claim 16 wherein one of the two triangular portion edges slides against the second member axial surface when the rotatable member rotates in a first direction about the central axis and the other one of the two edges slides against the second member axial surface when the rotatable member rotates in a second, opposing direction about the central axis.

18. The seal assembly as recited in claim 1 wherein the elastomeric seal body has generally V-shaped axial cross-sections and an inner circumferential surface sealingly engageable with the first member outer circumferential surface.

19. A seal assembly for sealing a space between first and second members, the first member having a central axis and an outer circumferential surface extending about the axis, the second member having a radially-extending axial surface, at least one of the first and second members being a rotatable member, the seal assembly comprising:
a generally annular elastomeric seal body disposed about the first member outer surface and extending circumferentially about the central axis, the body including a base portion and a sealing portion having an inner end integrally formed with the base portion and an outer, free end sealingly engageable with the second member axial surface so as to define a generally annular seal interface;
a first wiper coupled with the seal body and having an engagement portion contactable with the second member axial surface at a position spaced radially outwardly from the sealing portion outer end; and
a second wiper spaced circumferentially about the axis from the first wiper, the second wiper being coupled with the seal body and having an engagement portion contactable with the second member axial surface at a position spaced radially outwardly from the sealing portion outer end.

20. The seal assembly as recited in claim 19 wherein the engagement portion of each of the first and second wipers is configured to direct substances disposed on the second member axial surface generally away from the sealing interface when each wiper contacts the substances during rotation of the rotatable member.
